(19) United States
(12) Patent Application Publication
(10) Pub. No.: US 2023/0132424 A1
(43) Pub. Date: May 4, 2023

(54) Bottling device

(71) Applicant: Industria di Leivi Srl, Leivi (GE) (IT)

(72) Inventors: Marcella Gai, Busalla (GE) (IT); Corrado Iozzia, Leivi (GE) (IT); Roberto Ghisilieri, Leivi (GE) (IT)

(21) Appl. No.: 17/691,510

(22) Filed: Mar. 10, 2022

(30) Foreign Application Priority Data
Nov. 3, 2021 (IT) 102021000005753

(51) Int. Cl. B67C 7/00; B67C 3/16

(52) U.S. Cl. CPC B67C 7/0073; B67C 7/0093; B67C 3/16

(57) ABSTRACT

A device for bottling one or more bottles adapted to contain a liquid includes a filling unit of the bottles, which includes a filling system and a dispensing system of the liquid, and a capping unit of the bottles.

### FIELD OF THE INVENTION

The present invention relates to a device for bottling one or more bottles adapted to contain a liquid.

As will be apparent from the following description, the device object of the present invention relates to any filling liquid, whether food such as wine, beer or the like, or non-food, such as detergents or the like.

Therefore, the device of the present invention is not limited to food drinks, a field in which, however, it has particular advantages.

In particular, the device object of the present invention relates to bottling systems related to an artisan production, i.e., systems which are not connected to industrial processes, nor to automated bottle production processes.

Advantageously, the invention also relates to bottling food products such as wines, beers or the like.

### BACKGROUND OF THE INVENTION

In the state of the art, devices related to filling bottles are known, such as the devices described within patents 102000900898582 and 101989900083994, the content of which is to be considered an integral part of the present patent application.

However, the devices known in the art are particularly limited as they do not allow to treat a bottle from the filling to the possible sale or use of the liquid contained.

The complete processing of a bottle, from filling to labelling, is currently only available in industrial plants which, due to production needs, require the use of large machinery capable of producing a large number of bottles.

Such industrial plants also include the use of bottle conveyor belts, which move them from one station to another, automatically and quickly, so as to obtain as many bottles as possible.

It is evident that such systems cannot be used in the home, both for the size of the machinery, and for the needs of the users, who generally do not need automation, on the contrary they want to control the bottles station by station, so as to modify the operating parameters of the system as they wish, for example by increasing/decreasing the amount of filling liquid or the amount of sugars.

Therefore, there is a need not met by the devices and systems known in the state of the art to create a bottling device which allows to obtain a finished product, usable by users, but which does not require the space and the means necessary for the creation of an industrial plant and above all which does not require complex automation structures.

### SUMMARY OF THE INVENTION

The present invention achieves the above objects by creating a device as previously described, in which the device comprises a bottle filling unit, filling means and dispensing means of said liquid.

The device further comprises a bottle capping unit.

The device object of the present invention allows to obtain a bottling station and a station for capping filled bottles in a single system.

Both the filling unit and the capping unit are limited in size, so that they can be housed on a single workbench and thereby be able to create an artisan production of bottles, which can be installed at home.

Preferably the user manually moves the bottle from the bottling unit to the capping unit, no automatic bottle conveying means such as conveyor belts or complex electronic control systems are required.

Therefore, the device of the present invention does not have machinery, it is identified within the category of equipment, as it does not have self-propelled parts, as in industrial machinery.

Starting from this general minimum configuration concept of the device object of the present invention, it is possible to include several additional components, always maintaining the objects and objectives of the present invention, i.e., to simplify the production plants of bottles known at an industrial level, to allow artisan and home-made productions of beers, wines or the like.

In fact, the present invention allows to create a multi-station bottling machine with manual movement, particularly useful in the hobby field.

As will be apparent from the illustration of an illustrated embodiment, the device object of the present invention is readily adaptable to both bottling beer bottles, wine bottles, and any food beverage.

Unlike the systems known in the art, the device object of the present invention can bottle both carbonated beverages and uncarbonated beverages.

According to a preferred embodiment, in particular for bottling beers which ferment in the bottle, additive injection means are included inside the bottles, included upstream of the capping unit.

As will be apparent from the illustration of an embodiment, the device object of the present invention is particularly compact and allows to speed up the bottling procedure of each individual bottle, since the bottle is ready in a few simple steps, from filling to capping.

In artisan productions, the bottle closing speed is a crucial aspect for the success of the final product.

Advantageously, the injection means comprise an additive tank containing an injection liquid, which tank is connected to an injection syringe.

Preferably the filling means comprise a vacuum pump.

Therefore, the device of the present invention uses the vacuum as a tool for filling the bottles.

In combination with such a configuration, it is possible to envisage that the filling means comprise a vacuum tank, in communication with the vacuum pump and with the dispensing means.

As anticipated, the vacuum is the preferred mode of the device object of the present invention and to carry out the filling, however, it is also possible to include volumetric, isobaric pumps, in combination with devices for counting litres or the like.

For example, for filling carbonated beverages or non-glass containers, such as plastic or aluminium, it is preferable not to use the vacuum.

Therefore, according to a possible embodiment, the filling unit comprises means for detecting the amount of liquid dispensed by the dispensing means.

According to a further refinement of such a variant, the detection means can consist of means for weighing the bottle.

It is also possible to include sensors for detecting the amount of liquid dispensed, just as it is possible to include optical means for measuring the level of liquid inside the bottle.

It should be specified that the weighing means included for detecting the amount of liquid dispensed, can also be included for the injection means, so as to detect the amount of additives inserted inside the bottle.

Furthermore, as described for the filling unit, optical systems or sensor systems can also be used to detect the amount of additives injected.

According to a further embodiment, the device object of the present invention includes means for detecting the temperature of the liquid and/or the additives.

According to a further embodiment variant, it should be specified that the bottling device object of the present invention can include means for sterilizing the bottles.

Advantageously, two possible embodiments of the sterilization means can be included.

The sterilization means can simply consist of bottle cleaning means.

The sterilization means can comprise a washing unit placed upstream of the filling unit, which comprises dispensing nozzles of a sanitizing liquid and bottle drying means.

Before being filled, the bottle is washed with a special solution emitted by the dispensing nozzles, to then be dried, or through special means, such as dispensing means of a hot air flow or, for example, means aimed at inverting the bottle, to allow the elimination of the excess sanitising liquid.

Alternatively or in combination with such a solution, the sterilization means can comprise ultraviolet ray generating means.

Such means must be included downstream of the filling unit and can be aimed at sterilising even only a part of the bottle, in particular the part of the neck of the bottle which is not filled with liquid.

Such means can for example consist of a beak element which is inserted inside the neck of the bottle and emits ultraviolet rays along the internal walls of the neck of the bottle, up to the interface area with the liquid.

According to a further embodiment, bottle integrity detection means can be included.

Such means can consist of optical systems or imaging and image processing systems which detect any defects in the material forming the bottle.

According to an improvement of the device object of the present invention, bottle labelling means are included, which comprise means for printing one or more labels and means for fixing said labels to said bottles.

Finally, according to a further embodiment, it is possible to include means for filtering the liquid to be injected into the bottles.

As is evident from the description just given and from the illustrated embodiment appended to the present patent application, a bottling device capable of responding and adapting not only to the types of beverage used, but also to the needs of the users, is created.

These and further objects of the present invention are achieved by a bottling device according to the appended independent claim and the dependent claims.

### BRIEF DESCRIPTION OF THE DRAWINGS

Optional features of the device of the invention are contained in the attached dependent claims, which form an integral part of the present disclosure.

These and other features and advantages of the present invention will become clearer from the following description of some exemplary embodiments illustrated in the accompanying drawings in which:

FIGS. 1a to 1d show different perspective views of a preferred embodiment of the bottling device object of the present;

FIGS. 2a and 2c show three details of the bottling device shown in FIGS. 1a to 1d.

### BRIEF DESCRIPTION OF EMBODIMENTS OF THE INVENTION

It should be noted that the embodiments shown in the figures attached to the present patent application are shown to better understand the advantages and features of the device object of the present invention.

Such embodiments are therefore to be understood as purely illustrative and not limiting the inventive concept of the present invention, namely to create a bottling device which allows to carry out all the necessary processes to obtain a finished product, i.e., a filled and closed bottle, ready for consumption, without requiring the constructive complexity of the bottling plants known at an industrial level, which require complex automation systems.

Furthermore, the attached figures refer in particular to a procedure for bottling beer bottles, but, based on what has been described above, the device object of the present invention can be used to fill bottles, and not only, of beer, wine, any food substance and non-food substance.

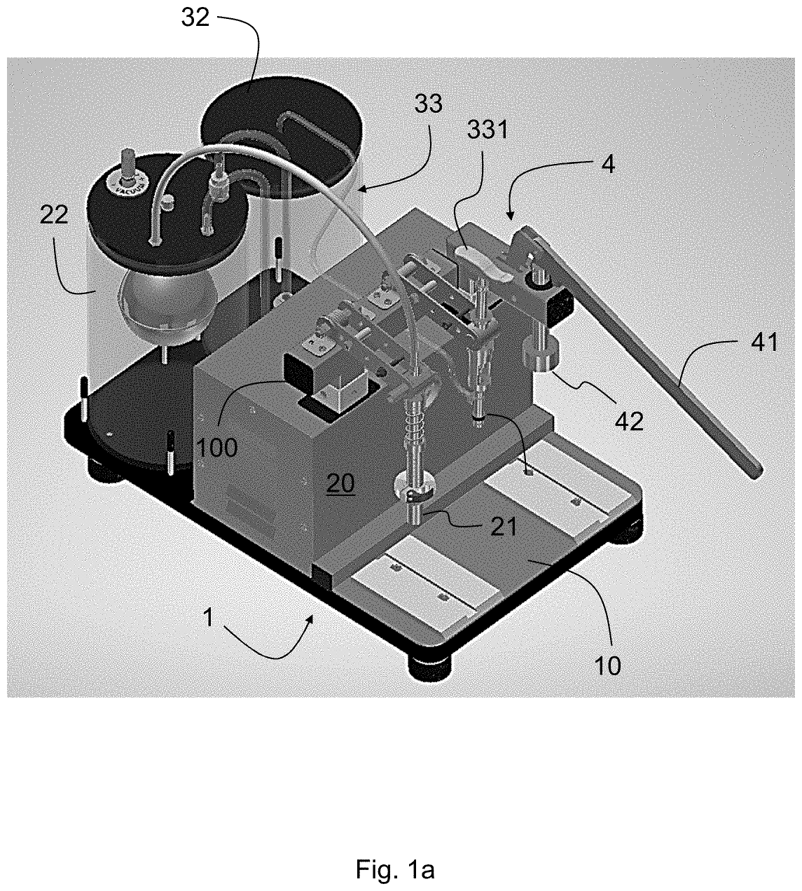

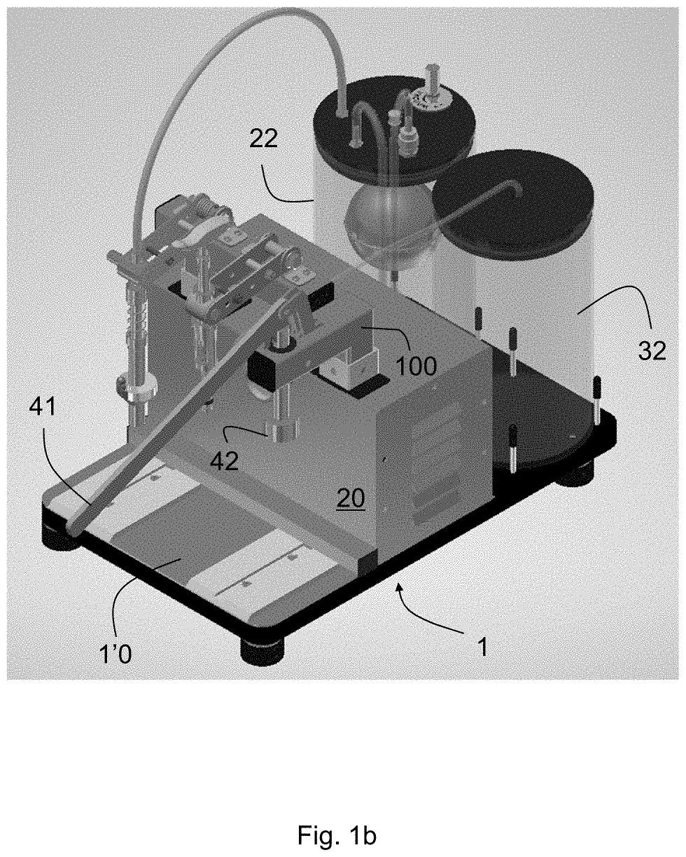

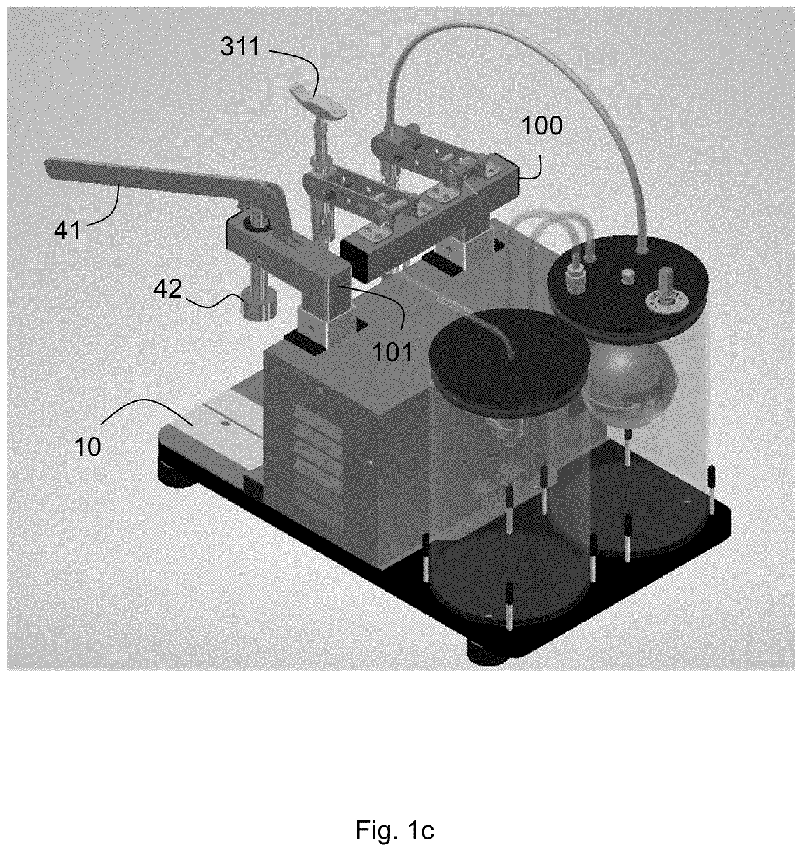

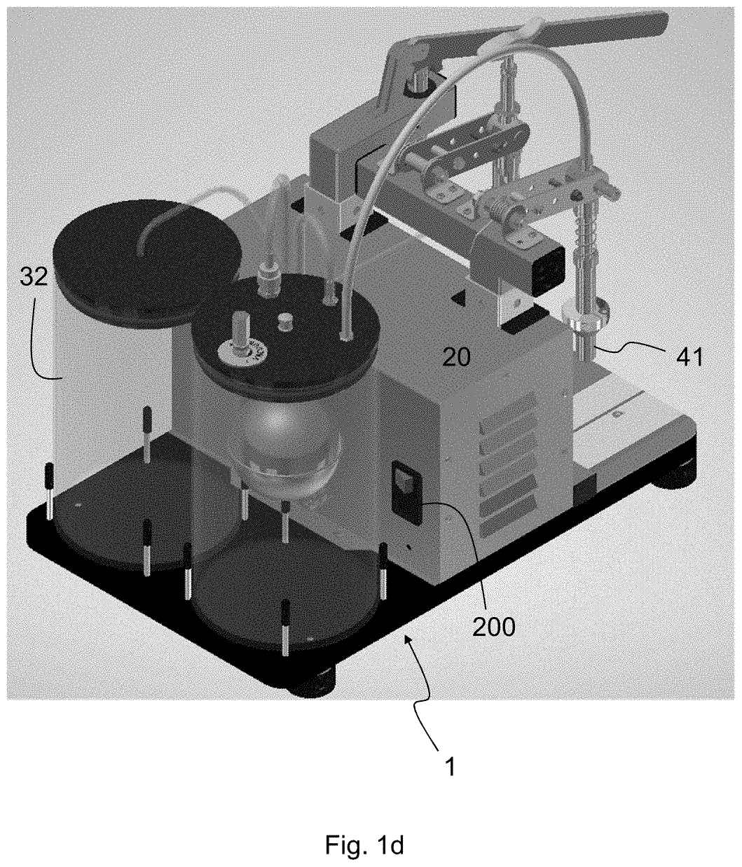

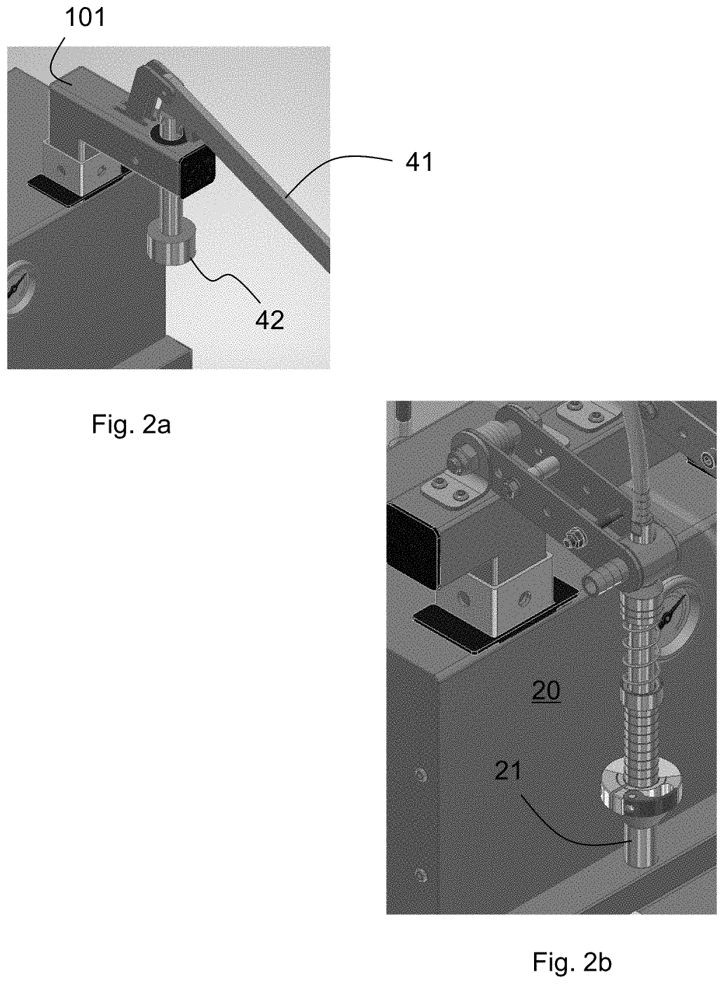

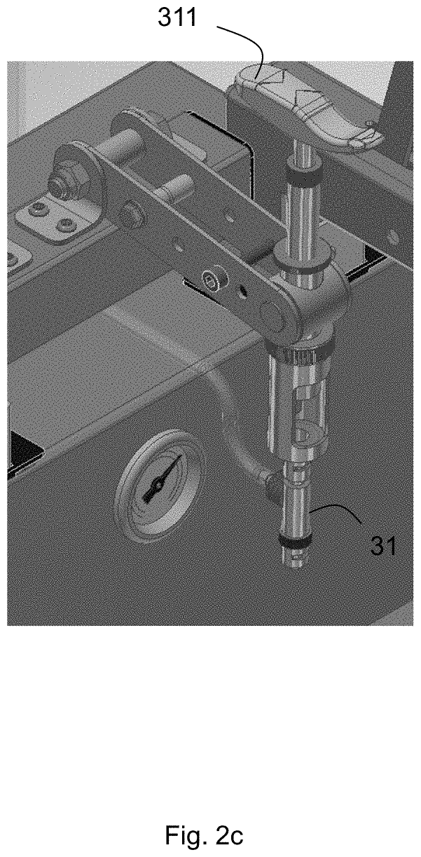

With particular reference to FIGS. 1a to 1d, the device object of the present invention comprises a support base 1 extending along the entire length of the device.

The support base 1 comprises a worktop 10, on which it is possible to rest one or more bottles to be filled.

The functional units of the embodiment illustrated in the figures are located above the worktop 10, which functional units, described in detail below, allow filling the bottle, the injection of additives and capping the bottles.

In particular, the filling of the bottles is ensured by filling means.

Such filling means comprise a vacuum pump, not illustrated in the figures, inserted inside the outer casing 20, a vacuum tank 21 and a dispensing nozzle 21.

In particular, the vacuum tank draws the liquid to be inserted inside the bottle from any container, not shown in the figure, containing said liquid, creates the vacuum inside the bottle, so that the liquid in the container fills the bottle up to a certain level.

The filling level is ensured by the presence of the dispensing nozzle 21, as soon as the liquid reaches such a level, the presence of the vacuum inside the bottle ceases and the filling action is interrupted.

The filling means further comprise a vacuum tank 22 which has a dual function.

Firstly, the vacuum tank 22 forms the lung of the vacuum pump and, secondly, it can collect the excess liquid inserted inside the bottles and transmitted from the dispensing nozzle 21 to the vacuum tank 22.

An entirely similar operation is described within patents 102000900898582 and 101989900083994, the contents of which are to be considered an integral part of the present patent application.

The bottle is then placed on the worktop 10 at the dispensing nozzle 21, is filled and can then be moved to the second station, i.e., at the injection means.

Regardless of the construction of the filling means and regardless of the presence of the injection means, according to an embodiment variant, means can be included for filtering the liquid adapted to fill the bottles.

Such filtering means can be made in any manner known in the state of the art and are preferably included upstream of the nozzle 21, so as to filter the liquid entering or exiting the nozzle 21.

The filtering means could, for example, be included at the vacuum tank 22, upstream of the tube connecting the liquid container to the nozzle 21.

Therefore, the filtering means can be included in the device object of the present invention, in combination with the filling means and the capping unit, with or without the presence of the injection means.

The injection means allow the injection of additives inside the bottle, such as additives known as “primers”, i.e., a mixture of water and sugars, used in the production of beers to ensure the fermentation thereof.

The injection means comprise an injection syringe 31 connected to an additive tank 32, which contains precisely the additive to be injected.

The injection syringe 31 can be made according to any of the methods known in the state of the art and, according to the variant shown in the figures, is manually operated, comprises a handle 311 on which the user acts.

The operation of the syringe 31 envisages that the pressure of the handle 311 allows to inject, inside the bottle located below such a syringe, a predetermined amount of additive.

At the same time, the syringe is configured to draw the same amount of additive from the tank 32.

Therefore, during a single pressing action, the syringe 31 injects the additive inside the bottle and draws the same amount from the tank 32.

It should be specified that the injection means can be included at any point of the processing; in fact, they can be included before or after filling, just as they can be integrated inside the filling means.

FIGS. 1a to 1d further illustrate the connecting duct 33 between the tank 32 and the syringe 31.

Once the necessary additive has been injected, the bottle can be capped, whereby it is moved along the worktop 10 at the capping unit 4.

The capping unit 4 is made according to the methods known in the state of the art and has a lever 41 which acts on a fixing terminal 42, aimed at tightening the crown cap on the side edges, so as to deform such edges and make them adhere to the terminal part of the neck of the bottle, at the opening mouth.

The oscillation of the lever 41 allows the approaching/distancing of the terminal 42 with respect to the bottle to be capped, as well as the fixing of the cap to the bottle.

As anticipated and as clearly shown in the figures, a peculiar aspect of the device object of the present invention is the compactness.

In fact, the support base 1 allows to support and join all the components of the device itself.

In particular, the support base 1 supports the outer casing 20 of the vacuum pump, which is parallelepiped in shape.

The outer casing 20 is positioned in an intermediate position of the support base 1, so as to include, on the one hand, the worktop 10, and on the other hand allows the two tanks 22 and 32, described above, to be housed.

Furthermore, as shown in the figures, the outer casing 20 has the upper face aimed at fixing the dispensing nozzle 21, the injection syringe 31 and the capping unit 4.

To confer constructive simplicity, such components are fixed to a single beam 100 integral with the outer casing 10.

It is therefore evident that the dispensing nozzle 21 and/or the injection syringe 31 and/or the capping unit can be easily replaced and disassembled, for repair or even to adapt the device object of the present invention to different operating needs.

Alternatively, as shown in FIGS. 1c and 1d, it is possible to include that the beam 100 connects the syringe 31 and the nozzle 21, while the capping unit 4 is mounted with an independent support 101.

Obviously, different configurations are possible, so as to make the device object of the present invention more usable and adaptable to operating needs.

While the invention is susceptible to various modifications and alternative constructions, some preferred embodiments have been shown in the drawings and described in detail.

It should be understood, however, that there is no intention of limiting the invention to the specific illustrated embodiment but, on the contrary, it aims to cover all the modifications, alternative constructions, and equivalents falling within the scope of the invention as defined in the claims.

The use of “for example”, “etc.”, “or” refers to non-exclusive non-limiting alternatives, unless otherwise stated.

The use of “includes” means “includes but not limited to”, unless otherwise stated.

The invention claimed is:

1. A device for bottling one or more bottles adapted to contain a liquid, comprising:
a filling unit of the bottles, the filling unit having filling means and dispensing means the liquid; and
a capping unit of the bottles.

2. The device according to claim 1, further comprising injection means of additives inside the bottles, the injection means being arranges upstream of the capping unit.

3. The device according to claim 2, wherein the injection means comprise an additive tank containing an injection liquid, the additive tank being connected to an injection syringe.

4. The device according to claim 3, wherein the filling unit comprises a vacuum pump.

5. The device according to claim 4, wherein the filling unit comprises a vacuum tank in communication with the vacuum pump and with the filling unit.

6. The device according to claim 5, further comprising a worktop on which the one or more bottles to be filled are arranged, the worktop being fixed to an outer casing containing the vacuum pump, the outer casing supporting at least the filling unit and the capping unit.

7. The device according to claim 6, wherein the outer casing has, on one side facing the worktop, at least the filling unit and the capping unit, and, on an opposite side, the additive tank and the vacuum tank.

8. The device according to claim 6, further comprising a support base, the support base comprising the worktop, and the outer casing resting on the support base,
the additive tank and the vacuum tank being fixed to the support base,
the outer casing being constructed as a parallelepiped-shaped element, which has, on a side facing in a direction opposite to the worktop, the filling unit, the injection syringe and the capping unit.

9. The device according to claim 1, further comprising a filtering unit for filtering the liquid.

10. The device according to claim 1, further comprising a sterilizing unit for sterilizing the bottles.
